(19) United States
(12) Patent Application Publication
(10) Pub. No.: US 2005/0251416 A1
(43) Pub. Date: Nov. 10, 2005

(54) Methods for improving the clinical outcome of patient care and for reducing overall health care costs

(76) Inventor: Jeffrey C. Greene, Norman, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 10/841,240

(22) Filed: May 6, 2004

(51) Int. Cl. G06F 17/60

(52) U.S. Cl. 705/2

(57) ABSTRACT

The current invention is directed to improved methods for providing health care and for reducing the costs of health care. Additionally, the methods of the current invention are designed to improve the clinical outcome for the patient. The methods of the current invention provide financial incentives to both the patient and the medical service provider is an integrated manner that encourages patient empowerment, patient and physician accountability and appropriate checks and balances by incorporating evidence-based medicine treatment guidelines and content and other similar types of content through an Internet application or by other means to improve the clinical outcome of the health care treatment and to reduce the overall costs of health care.

### BACKGROUND OF THE INVENTION

The current invention is directed to improvements in the delivery of health care. In particular, the current invention provides a health care delivery system that utilizes evidence based medicine (EBM) and other types of health care quality improvement content with a pay-for-performance arrangement through an Internet application to enhance clinical outcomes while lowering overall medical costs. Further, the methods disclosed herein provide improvements to the methods disclosed in co-pending U.S. patent application Ser. No. 10/441,975, filed on May 20, 2003.

As a result of years of double digit inflation, health care has grown to become the largest industry sector in the U.S. economy. Representing 15% of the country's GNP, Americans spend more than twice what citizens of other developed countries spend on health care. A growing number of Americans are losing their health insurance because it is becoming increasingly unaffordable. Current estimates place the number of uninsured at 45,000,000. Fortune 500 companies have declared the current health care delivery system as unsustainable.

Since the mid-1980s, several attempts have been made to control the overall cost of the United States health care delivery system. These attempts include the Clinton single payer system, capitated health maintenance organizations (HMOs), gatekeeping, pre-certification and now consumer-driven health care. Unfortunately, these attempted reforms only temporarily slowed the increasing cost of health care during the mid to late 1990s. More recently, health care costs have been escalating at an alarming rate. In fact, based on currently available data, health care costs during 2001, 2002 and 2003 increased at about three to four times the rate of inflation. Therefore, a need exists for improved methods of delivering health care. Any health care reform should provide the means to control overall health care costs and should enhance the clinical outcome of medical treatment for the patient. In order to achieve these goals, the current invention provides a method of delivering health care that achieves these goals by focusing on the parties having the greatest degree of control over costs and clinical outcome.

The general public normally views the patient and doctor as the health care system's primary components. However, many other elements contribute to the overall effectiveness and cost of health care delivery. The following discussion of the modem health care system will aid in understanding the advantages of the current invention.

Medical providers are the most visible component of the health care system. Providers include medical practitioners, e.g. doctors, hospitals pharmacies, medical laboratories, and other similar service providers. Health care payors are an equally important part of the health care system. Health care payors are those parties responsible for compensating the health care providers. Health care payors include insurance companies, HMO's, self-insured employers, Medicare, Medicaid, and patients without insurance. Another component of the health care system is the health care purchaser. Health care purchasers include patients without insurance or having insurance but responsible for a portion of health care cost, private employers and governments. Finally, there are those entities that assume the risk of paying for health care. These entities include the patient (co-pay, deductible or uninsured), the health insurance company, the self-insured employer, the government and medical groups such as HMO's.

A preferred provider organization (PPO) is a familiar means for delivering health care. PPO's offer health care purchasers access to a group of medical providers through a contractual arrangement that establish standards of care, reimbursement rates (allowables), timeliness of payments and other terms and condition. In addition, the PPO contract establishes the covered medical services terms for filing and paying claims; balance billing patients for annual deductibles and co-payments; credentials necessary to be a medical provider in the PPO; appeals processes; termination; and, other administrative arrangements.

Further, the PPO provides necessary information to the health care purchaser such as directories of medical care providers, performance statistics and other pertinent data. Some PPOs may also re-price claims. Re-pricing is the process of reducing the prices of charges on an insurance claim submitted by the provider to the PPO for payment from the provider's fees to the contracted PPO allowables. Once a claim is re-priced, it is adjudicated. Adjudication is the process of determining who and how much is to be paid on a health care claim. There are a number of criteria that must be considered as part of the adjudication process to include: patient eligibility for coverage; provider participation in the PPO; coverage of services submitted by the provider based on such factors as patient diagnoses, service frequency limits and correct coding of services and diagnoses; status of annual deductible and co-payments, the presence of other insurance coverage; etc. Adjudication is typically performed by third party administrators, health insurance companies or government program intermediaries.

The final ingredient in the health care delivery process involves who is responsible for paying for the services. Obviously, patients pay for a portion or all of their health care. The government pays for health care under the Medicare, Medicaid and Champus programs. Health insurance companies and self insured employers also pay for health care. When a third party (other than the patient or the provider) pays for health care, we generally refer to this as health insurance and refer to the process of health insurance as the assumption or the underwriting of health insurance risk or the assumption of risk. PPOs do not assume or underwrite risks unless the PPO is owned and operated by a health insurance company.

Health Maintenance Organizations (HMOs) differ from PPO's by more actively managing health care delivery. HMOs attempt to control health care costs by controlling the volume of services rendered. The most famous and controversial method used by HMOs to control costs is by pre-paying providers to care for a certain number of patients. These payments are referred to as capitations. This method shifts the financial risk for health coverage from an insurer to the provider. According to the pre-payment theory, providers earn more by managing the patient care. However, this can also translates as restricted patient care. In other words, providers can improve their financial results by restricting care to HMO patients. After a series of lawsuits by patients against their providers, the government began to consider a “Patients Bill of Rights” to protect patients from overly restricted care. This condition has damaged the reputation of HMOs with the public.

HMOs and PPOs use other cost control or medical management techniques such as requiring pre-certification authorization of surgical procedures and other special medical treatments. Some HMOs and PPOs incorporate a “gatekeeper,” such as a primary care physician, to control access to more expensive treatments and medical specialties. Other HMOs and PPOs attempt to control costs by active disease management or case management. These techniques focus on helping patients with conditions that tend to be expensive to treat to achieve better clinical results and to control costs. Some HMOs and PPOs also encourage preventative medicine as a means to improve health and control costs. HMOs and PPOs tend to earn high marks when they promote preventive medicine as means for precluding the onset of a more serious and costly medical condition.

Insurance companies that provide health coverage frequently use organizations such as PPO's and HMO's to manage costs and limit risk exposure. Insurance companies may choose to not use independent HMOs or PPOs and instead create their own HMOs and PPOs by negotiating terms and fees directly with health care providers.

As stated earlier, a health care purchaser normally pays a “co-pay” and an annual deductible when treated by a health care provider under contract with an insurance company, PPO, HMO or the government. The insurance company covers the remainder of the health care provider's fee paying the fee when the provider submits a claim for reimbursement. Frequently, the medical provider submits the claim to an HMO, PPO or the employer. These organizations re-price the claim according to the agreed upon rate schedule and provide payment to the health care provider. For the purposes of this disclosure the party or parties receiving the claim and directing the payment thereof is referred to as a payor. The payor may optionally re-price the claim on behalf of the party responsible for the actual costs of the medical services.

Finally, many self-insured employers purchase re-insurance. The re-insurance protects the employer against the cost of a catastrophic case (i.e. “specific coverage”) and/or instances where the self-insured employer's total health care costs for the year exceed a given dollar amount (i.e. “aggregate coverage”). This type of insurance is also referred to as “stop loss” coverage.

Except for the efforts of the HMO, the current health care delivery system lacks a mechanism for controlling health care costs. In fact, PPOs and government programs essentially reward providers for over utilization or over consumption of health care resources, thereby driving up the overall cost of health care. The efforts of HMO's to control costs through managing care have increasingly come under attack from health care purchasers and providers. In particular, the methods of some HMO's give the appearance of dictating health care practices without adequate concern for the clinical outcome of the patient. Therefore, an improved system for controlling costs and improving the clinical outcome of the patient is needed for the health care delivery system.

### SUMMARY OF THE INVENTION

The current invention provides improved methods for delivering health care services. In one embodiment, the current invention comprises the steps of medical practitioner such as a physician submitting a claim for compensation to a health plan. The claim is preferably submitted electronically to a health plan computer. The claim includes at least one diagnosis code corresponding to at least one medical treatment provided to a patient. Upon receipt, the diagnosis code is compared to a data base of medical diagnoses. If the diagnosis code corresponds to a medical diagnosis in the data base, then a notice is sent to the medical practitioner advising the practitioner that EBM guidelines for the medical diagnosis are available for review. The medical practitioner is provided access to a website. The website provides the medical practitioner with access to EBM treatment guidelines and other forms of health care information. The medical practitioner accesses the website and the website requests confirmation from the medical practitioner of medical treatment within the scope of the EBM treatment guidelines. Additionally, the website monitors the medical practitioner's usage of the website and review of the EBM treatment guidelines. In response to the medical practitioner's input regarding treatment of the patient, the website selects a compensation scale for reimbursing the medical practitioner. The website further provides the medical practitioner with the option of prescribing Ix for the patient. If the medical practitioner prescribes Ix, then the website automatically generates a notice for transmission to the patient.

In another embodiment, the current invention provides a method for delivering health care comprising the steps of health plan computer receiving a claim for medical services from a medical practitioner. The claim includes at least one code corresponding to at least one medical diagnosis. The code is compared to a data base of medical diagnoses. If the code corresponds to a medical diagnosis in the data base, then a notice is sent to the practitioner advising the practitioner that EBM guidelines for the medical diagnosis are available for review. The medical practitioner is provided access to a website. The website provides the medical practitioner with access to EBM treatment guidelines and other forms of health care information. The medical practitioner accesses the website and the website requests confirmation from the medical practitioner of medical treatment within the scope of the EBM treatment guidelines. The website further provides the medical practitioner with the option of prescribing Ix for the patient. If the medical practitioner prescribes Ix, then the website automatically generates a notice for transmission to the patient. The website also provides the patient with access to medical information relating to the medical diagnosis and a knowledge exam designed to determine if the patient understands of the medical diagnosis and treatment. During the patient's access of the website, the website monitors the patient's use of medical information. The website automatically scores the knowledge exam and provides the patient with the means to forward the knowledge exam results to the patient's health plan.

In yet another embodiment, the current invention provides a method for delivering health care. The method of the current invention comprises the steps of medical practitioner such as a physician submitting a claim for compensation to a health plan. The claim is preferably submitted electronically to a health plan computer. The claim includes at least one diagnosis code corresponding to at least one medical treatment provided to a patient. Upon receipt, the diagnosis code is compared to a data base of medical diagnoses. If the diagnosis code corresponds to a medical diagnosis in the data base, then a notice is sent to the medical practitioner advising the practitioner that EBM guidelines for the medical diagnosis are available for review. The medical practitioner is provided access to a website. The website provides the medical practitioner with access to EBM treatment guidelines and other forms of health care information. The medical practitioner accesses the website and the website requests confirmation from the medical practitioner of medical treatment within the scope of the EBM treatment guidelines. Additionally, the website monitors the medical practitioner's usage of the website and review of the EBM treatment guidelines. In response to the medical practitioner's input regarding treatment of the patient, the website selects a compensation scale for reimbursing the medical practitioner. Preferably, the website selects between at least three pay scales in response to input received from the medical practitioner. The website further provides the medical practitioner with the option of prescribing Ix for the patient. If the medical practitioner prescribes Ix, then the website automatically generates a notice for transmission to the patient. The website also provides the patient with access to medical information relating to the medical diagnosis and a knowledge exam designed to determine if the patient understands of the medical diagnosis and treatment. During the patient's access of the website, the website monitors the patient's use of medical information. The website automatically scores the knowledge exam and provides the patient with the means to forward the knowledge exam results to the patient's health plan. Additionally, the website permits transmission of the patient's actual answers to the medical practitioner.

### BRIEF DESCRIPTION OF THE DRAWINGS

FIG. 1 graphically demonstrates the parties primarily in control of health care costs.

FIG. 2 graphically depicts the current allocation of the health care insurance premium

FIG. 3 is a flow chart representing the medical practitioner's portion of the Program.

FIG. 4 is a flow chart representing the patient's portion of the Program.

### DETAILED DISCLOSURE OF THE PREFERRED EMBODIMENTS OF THE CURRENT INVENTION

The current invention provides methods for improving patient clinical outcomes while simultaneously lowering overall health care costs. The improved health care delivery methods achieve the desired results by focusing on those parties having the greatest control over health care costs, i.e. the physician and the patient. In particular the current invention integrates the roles of the patient and physician in determining the clinical outcome of the medical treatment and the costs associated with the treatment.

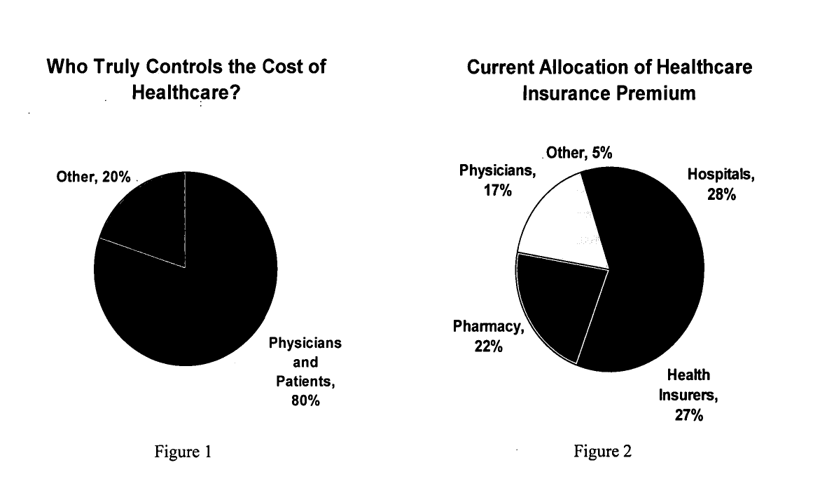

The total cost of health care is reflected by the following mathematical formula:
TOTAL COST=(UNIT PRICE)(UNITS OF TREATMENT)(PATIENT COMPLIANCE)
This formula demonstrates that medical providers and patients exert the greatest influence on total health care costs. However, in current health care delivery systems these two groups have too little influence over the payment of health care costs. Rather, the primary health care payors and deliverers of health care are insurance companies, PPOs, HMOs, self-insured employers, Medicare, Medicaid, and patients without insurance. As a result, a dichotomy exists between the efforts to deliver quality health care and the effort to control health care costs. FIG. 1 demonstrates that patients and physicians control about 80% of the costs associated with health care. Yet, as shown in FIG. 2, physicians receive less than 20% of every health care dollar.

Providing quality health care at an affordable cost requires a system designed to overcome this dichotomy. Preferably, the system will provide suitable incentives to both the patient and the medical provider to bring about a change in behaviors resulting in better clinical outcomes for the patient while lowering overall costs for the heath care system. Additionally, the improved method for delivering health care aligns the interests of all the key stakeholders in the health care industry. These key stakeholders are generally identified as physicians, patients, employers, insurers and hospitals. For the purposes of this discussion, the current invention focuses on services delivered by a medical practitioner such as a physician; however, the methods of the current invention apply equally well to all medical service providers. Since the health care delivery system provided herein will improve clinical outcomes and lower costs, the remaining stakeholders will be motivated to embrace the improved system.

The current invention provides these benefits by financially rewarding physicians and patients (through a “pay-for-performance” arrangement) each and every time health care is delivered by physicians and received and maintained by patients when they voluntarily follow and appropriately respond to evidence-based medicine (EBM) guidelines and content or other health care quality improvements and cost control methods through an Internet application or other means. Additionally, the current invention introduces a new concept to the health care system. Specifically, the current invention provides the means for both the physician and patient to practice “Information Therapy (Ix)”. Information therapy empowers the patient, allowing the patient to take an active role in managing their own health care, thereby improving their overall quality of life. Clearly, the combination of EBM and Ix Therapy will enhance the clinical outcome of medical treatments and lower overall health care costs.

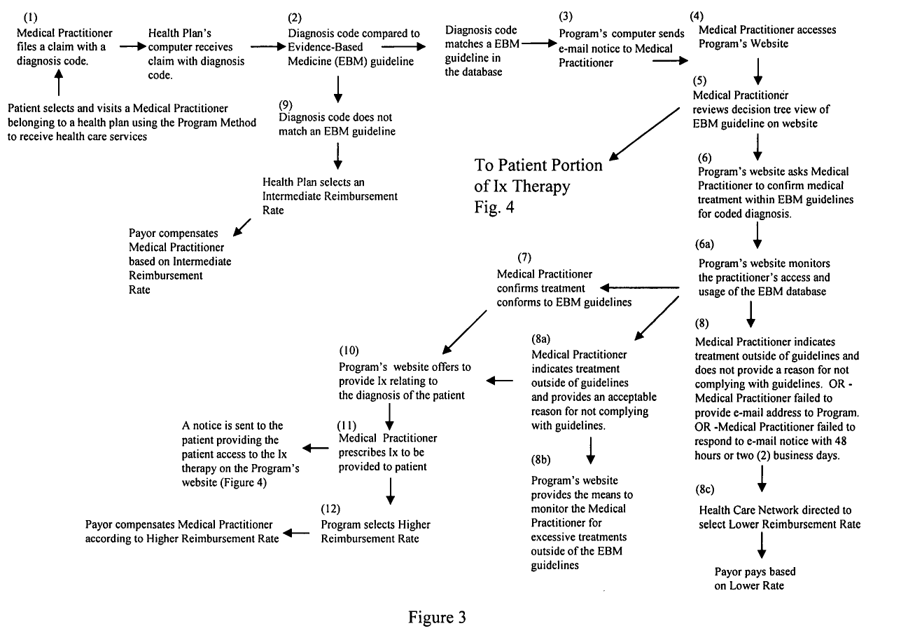

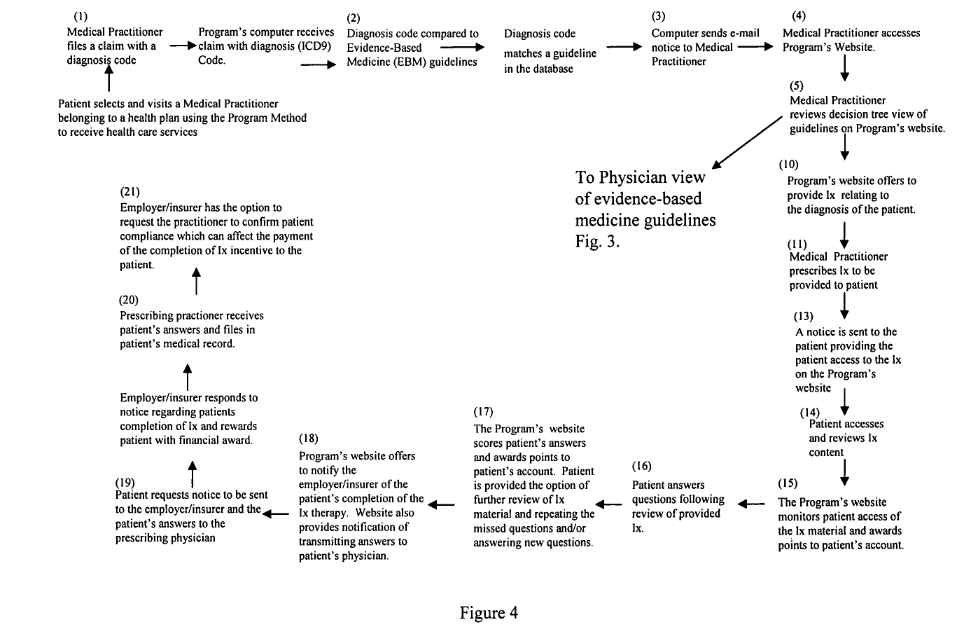

As an encouragement to practice Ix Therapy and to use EBM, the methods of the current invention enhance the financial outcome for both the patient and the physician (medical practitioner). The health care delivery methods of the current invention will be described with reference to FIGS. 3 and 4. To aid in identification of the various steps of the current invention, identifying numbers are provided for selected portions of the process. Electronic communications, such as but not limited to the Internet and e-mail, provide the most efficient means for practicing the methods of the current invention. However, the methods of the current invention may be readily adapted to traditional mail, faxes and other hard copy communications or a blend of electronic communication and traditional communications.

FIGS. 3 and 4 provide flow charts of the method for providing health care. FIG. 3 focuses on the physician's portion of EBM and Ix Therapy according to methods of the current invention. FIG. 4 focuses on the patient's portion of the current invention. While shown in step wise format, those skilled in the art will recognize that various portions of the process can be moved earlier and later in the charts. The methods of the current invention are designed to provide flexibility and adaptability depending on the desires of the local health plan. The format of the current invention may be adapted by any form of health plan. PPO's and fee-for-service governmental programs are particularly suited for performing the methods of the current invention. As used herein, the term health plan refers to the organization managing the health care delivery system and may include any payor type system including a self-insured employer.

As shown in FIG. 3, the method of the current invention begins with educating the patient and the medical practitioner on why and how the methods of the current invention (referred to herein as “the Program”) work. Prior to receiving treatment, the patient identifies a medical practitioner that participates in the Program. Typically, the Program will be administered or carried out by a health plan. For the purposes of this disclosure a health plan is any entity managing the delivery of health care through use of the current invention, i.e. the Program. The patient schedules an appointment with the participating practitioner and indicates that they are covered by the Program. The patient presents to the participating practitioner as a member of the Program, covered by EBM and the financial reward arrangement. Subsequently, the practitioner provides health care service to the patient in adherence to EBM or other health care quality improvement or cost control methods suggested by the Program. Following treatment of the patient, the medical practitioner files a claim for reimbursement with the Program. Preferably, the practitioner files the claim electronically (1). The medical claim contains information commonly found on current claim forms such as the patient's name, the practitioner's name, a primary medical diagnosis and the service provided by the practitioner. Preferably, the medical diagnosis is identified by a predetermined diagnosis code.

Upon receipt of the claim, the medical diagnoses are compared to a list of medical diagnoses contained in the Program data base (2). If the data base contains the diagnosis, then the practitioner receives a notification informing the practitioner that there are EBM guidelines available for review (3). In the preferred embodiment, a practitioner will file the claim electronically with the diagnosis identified by a predetermined code. A computer capable of comparing the diagnosis code to the Program data base receives the claim. If the encoded diagnosis matches the code for medical diagnosis within the Program data base, then the computer automatically transmits an email, fax or other electronic correspondence to the practitioner. Alternatively, the computer system prepares a regular letter for mailing to the practitioner. The notification sent to the practitioner advises the practitioner to access the practitioner's portion of the Program's website containing EBM guidelines or other health care quality improvement and cost control methods. The Program website is preferably a secure website requiring input of the practitioner's secret password to gain access to the data contained therein. Alternatively, these codes may be transmitted by a separate email or otherwise provided to the practitioner. The method for gaining access to the website is not critical to the current invention.

For the purposes of this disclosure the term website refers to the Program's website. The Program's website may or may not be located on a central server. Further, the patient and practitioner portions of the Program's website are not necessarily contained on the same computer system. As used herein, the practitioner portion of the Program's website will preferably be utilized by all parties authorized to access the medical practitioner's portion of the website including but not limited to nurses, nurse practitioners, physician assistants and other care providers.

Upon entry of the appropriate codes or passwords at the website (4), the website identifies the names of patients, the dates and types of services provided, the medical diagnoses and related medical services for the accessing practitioner or their authorized assistant. The website also provides the EBM guidelines or other health care quality improvement and cost control methods corresponding to each diagnosis. Preferably, the practitioner reviews and confirms the appropriateness of the information found on the website (5).

The Program's website is interactive. As such, it queries the practitioner concerning adherence to EBM guidelines or other health care quality improvement and cost control methods for the diagnoses (6). The practitioner's response to the query will determine the reimbursement rate used to compensate the practitioner for services rendered on each claim. If the practitioner confirms treatment within the scope of the EBM guidelines or other health care quality improvement and cost control methods (7), then the website will automatically direct compensation to be made according to a higher payment (practitioner reimbursement) rate scale (12). Preferably, the highest payment is selected only after the physician has prescribed Ix for the patient (10, 11). Typically, the medical practitioner must access the interactive website within 48 to 72 hours of receipt of the notification in order to qualify for the higher payment rate scale. In the preferred embodiment, the practitioner is required to respond to the notice within 48 hours or two business days. If the practitioner does not respond within the indicated period of time (8), then the website will direct compensation to be made according to a lower rate scale.

As previously indicated, the Program's website is interactive. To provide the maximum flexibility and greatest possibility of improved clinical outcome for the patient, the method of the current invention does not rigidly limit the practitioner only to the EBM guidelines in order to receive the highest degree of compensation. Rather, the Program's website provides the practitioner with the option of indicating the treatment falls outside of the guidelines while explaining the reason for prescribing treatment outside of the guidelines. Provided that the practitioner completes the section describing an appropriate reason for non-adherent treatment (8a), the Program's website will still select the highest compensation level for the practitioner (12). As previously indicated, in the preferred method the physician must prescribe Ix for the patient before becoming eligible to receive payment at the highest compensation scale.

While the practitioner is not required to indicate compliance with the EBM guidelines, failure to respond within 48 hours or indicating non-adherence without providing an appropriate reason for treatment outside of the EBM guidelines will have a negative financial impact on the practitioner. Specifically, these actions will trigger the computer system to select the lowest possible payment scale for the practitioner's services (8c). If the practitioner fails to prescribe Ix for the patient, then the website will direct the selection of the lowest payment scale for compensation of the practitioner.

Thus, the method of the current system provides a financial incentive to the physician to follow the EBM guidelines or to provide an appropriate reason for deviating from these guidelines. Additionally, the method of the current invention provides a financial incentive to the physician to prescribe Ix to the patient. In general, treatment according to the EBM guidelines and appropriate treatment outside of the guidelines will produce better clinical outcomes for the patient. Further, the prescription of Ix to the patient empowers the patient to be more compliant with their practitioner's treatment orders and instructions that Will normally improve the clinical outcome. Additionally, the patient's access to Ix provides the patient with the tools to control the medical condition thereby reducing doctor visits. Thus, the current invention provides a method for improving clinical outcome and for reducing health care costs. Clearly, the current invention integrates the activities of the patient and practitioner by encouraging the incorporation of EBM with Ix with financial incentives.

In order to provide practitioner compliance and to prevent fraud and abuse, the Program's website provides the means to monitor and audit the practitioner. In one aspect, the website provides the means for tracking the practitioner's access to the website. This tracking mechanism provides an indication of the practitioner's use of the EBM guidelines. For example, the Program's website tracks the access time for each webpage reviewed, if the time of usage for each page does not meet a predetermined minimum, then the practitioner may be questioned concerning the legitimate usage of the EBM guidelines. However, the predetermined minimum time period for accessing a webpage is not a rigid requirement. Rather, the minimum access time period may vary from practitioner to practitioner and from diagnosis to diagnosis based on various parameters such as but not limited to the practitioner's area of expertise and experience and whether a particular webpage has been previously reviewed and/or printed by the practitioner.

In another aspect, the website provides the means for monitoring the frequency of treatments outside of the EBM guidelines (8 and 8b). Thus, the current invention provides healthplans using the methods of the current invention with the ability to audit physicians who may not be using the best treatments for their patients by using treatments outside of generally accepted procedures. As indicated above the methods of the current invention are flexible and can be adjusted for individual practitioners on the basis of their practice area and experience.

Preferably, the medical practitioner accesses the website from time to time to obtain the current EBM guidelines for diagnoses common to the practitioner's field. Thus, the website provides an additional source of reference and education for the medical practitioner.

In instances where the medical practitioner's diagnosis does not correspond to a diagnosis contained in the EBM data base (9), then a notification to access the Program's website will not be sent to the medical practitioner. Under these conditions, the health care network will direct the payor to compensate the medical practitioner at an intermediate rate. Preferably, the medical practitioner will continue to file claims for compensation via email or other electronic means even when a guideline does not exist for a specific diagnosis. As noted above, an electronically filed claim is “read” by a computer. When the computer does not find a diagnosis code corresponding to a medical diagnosis in the Program's data base, the computer will automatically direct compensation to be paid according to an intermediate rate scale.

The foregoing steps of the method of the current invention provide an incentive to the medical practitioner to comply with the treatments specified in the EBM guideline data base. The treatments specified in the EBM data base are the preferred treatments as determined by leading medical schools in the United States. In particular, the following schools conduct rigorous reviews of medical conditions and provide guidelines for treatments generally accepted by medical practitioners as the preferred treatments for the identified medical conditions. Schools currently developing preferred treatment guidelines include: Duke, Vanderbilt, Emory, and Oregon Health and Science University.

Providing an incentive to the medical practitioner addresses only one part of the mathematical formula discussed above. In order to further improve the patient's clinical outcome and enhance health care cost control, the patient must also play a role. Accordingly, the methods of the current invention provide an incentive to the patient to take a pro-active approach to recovery from and prevention of medical conditions.

With reference now to FIG. 4, the method of the current invention provides the physician with the option of prescribing Ix for the patient (10). In the preferred embodiment, the method encourages the medical practitioner to prescribe Ix for the patient by rewarding the physician with a higher rate of compensation. Preferably, the practitioner will prescribe the Ix Therapy at the same time the practitioner is responding to the website's inquiry regarding compliance with EBM guidelines for the prescribed medical treatment. The prescribed Ix will normally be provided via an Internet website. For the remainder of this discussion, the source for the prescribed Ix will be referred to as the Program's website; however, other sources of information are within the scope of the present invention.

If the practitioner prescribes Ix for the patient (11), then a notice in the form of an e-mail, fax, letter or other similar communication will be sent automatically to the patient by the Program. This patient notification (13) may contain the medical information or more preferably the notice will contain the information required by the patient to gain access to the Program's website.

Upon receipt of the correspondence, the patient is expected to review the medical information made available by the Program's website (14). The review of the prescribed Ix material is supplemented with a questionnaire to be completed by the patient (16). In the preferred embodiment, the Program's website also provides the means to monitor the patient's access of the website and completion of the questionnaire (15). This monitoring aspect provides the network with the means to audit patient compliance with the Ix and other treatment prescribed by their practitioner. Further, the monitoring system provides the ability to award “points” to the patient for reading the Ix, and for answering questionnaires which indicate the patients' knowledge and adherence to recommended treatments. As a means to insure compliance and prevent fraud and abuse the network can designate a minimum period of access time necessary prior to awarding a point for reviewing that section of the Ix. By requiring a minimum time period, the method of the current invention ensures that the patient performs more than a cursory review of the information provided.

Following completion of the questionnaire, the website scores the patient's answers and awards points to the patient's account on the basis of the results (17). Following scoring, the patient has the option of further reviewing the Ix and repeating the questions or answering additional questions. Thus, the current invention provides the patient with the ability to gain further knowledge of their condition while enhancing the number of points awarded to their account. Clearly, the comprehensive nature and flexibility of the Program's website provides the patient with the tools necessary to improve the clinical outcome of their treatment and to improve their overall general health. Optionally, health care networks may elect to award patients with additional points for reviewing other medical information intended to improve health and control cost available through the website.

Upon completion of the Ix and indication of adherence and understanding, the patient is provided with a means for notifying the health care network of the receipt and review of the Ix material (18). Typically, the patient will be provided with an option box or other “clickable” device on the website to indicate the patient's desire to transmit a notice of completion to the health plan and/or employer. Due to the incentives offered by the method of the current invention, the patient will likely request a notice to be sent to the health plan and/or employer (19). Upon receipt of such notice, either the health care network and/or employer have the option of providing a financial reward to the patient for completing the Ix and indicating treatment adherence (21). In keeping with the flexible nature of the current invention, the financial reward may be granted upon the completion of each prescribed Ix portion. Alternatively, the party paying the reward may establish point thresholds for payouts. In the case of point thresholds, the patient's points are accumulated and upon reaching a predetermined level the financial reward can be paid to the patient.

In the preferred embodiment, the physician is included in the patient's Ix and indication of treatment adherence. At a minimum the preferred embodiment provides for the transmission of the patient's actual responses to the questionnaire completed in step 17. Further, the method of the current invention preferably includes physician confirmation of the patient's application of the Ix. For example, point awards may be conditioned upon the patient practicing the knowledge gained through Ix. Accordingly, if the patient has been diagnosed with heart disease and has indicated full treatment adherence but has not taken preventive measures indicated by the Ix such as exercising and quitting smoking, then the physician will be required to notify the network of the patient's lack of compliance. The network would then have the option of deducting points as well as adjusting the patient's co-pay and/or deductible and/or taking other more severe steps. The current invention also preferably provides for patient inquiries of the physician through the website, by e-mail or other similar means, during the Ix. Thus, the current invention integrates the patient's Ix with the physician's medical treatment.

In accordance with the Health Insurance Portability and Accountability Act, the notice to the health care network and any notices to any other third parties will not divulge any protected patient health information.

Clearly, the method of the current invention provides an incentive to the patient to take an active role in managing their medical condition. As a result, the clinical outcome of the patient's medical treatment will be enhanced. Thus, the methods of the current invention enhance the quality of medical care by encouraging the patient and medical practitioner through financial rewards to adhere to the scientifically proven best treatment guidelines or preferred methods and by enabling the patient to manage the treatment of the medical condition. By enhancing the quality of medical care and increasing the patient's ability to manage their medical condition, the current invention reduces the overall costs of health care while providing an increase in compensation to the medical practitioner.

Other embodiments of the current invention will be apparent to those skilled in the art from a consideration of this specification or practice of the invention disclosed herein. However, the foregoing specification is considered merely exemplary of the current invention with the true scope and spirit of the invention being indicated by the following claims.

1. A method for delivering health care services comprising the steps of:
receiving a claim for compensation for medical services from a medical practitioner for medical treatment of a patient, said claim including at least one diagnosis code corresponding to at least one medical treatment received by said patient;
determining if said diagnosis code corresponds to a medical diagnosis found in a data base of medical diagnoses;
sending a notice to the medical practitioner when said diagnosis code corresponds to a medical diagnosis found in said data base;
providing the medical practitioner access to a website, said website provides the medical practitioner with access to EBM treatment guidelines for said medical diagnosis;
said website requests the medical practitioner to confirm medical treatment within the scope of said EBM treatment guidelines;
monitoring the medical practitioner's access of said EBM treatment guidelines;
selecting a compensation pay scale in response to said medical practitioner's input received on said website;
said website providing said medical practitioner with the option of prescribing information therapy for said patient; and,
said website automatically generating a notice for transmission to a patient when said medical practitioner prescribes information therapy.

2. The method of claim 1, wherein said website receives the claim for compensation for medical services from a medical practitioner and said website automatically compares said medical diagnosis code to said data base of medical diagnoses.

3. The method of claim 1, wherein said website providing the means for monitoring the medical practitioner's access of said EBM treatment guidelines.

4. The method of claim 1, wherein said website automatically selects between at least two pay scales in response to input received from said practitioner.

5. The method of claim 1, wherein said website automatically selects between at least three pay scales in response to input received from said practitioner.

6. The method of claim 1, wherein said website automatically selects the lowest available pay scale when said medical practitioner does not prescribe information therapy for said patient.

7. The method of claim 1, wherein said website automatically selects an intermediate pay scale if the diagnosis code is not found within said data base of medical diagnoses.

8. The method of claim 1, wherein said website automatically selects the highest pay scale when said diagnosis code has a corresponding EBM treatment guideline and said medical practitioner indicates compliance with the said EBM treatment guideline.

9. The method of claim 1, wherein said website automatically selects the highest pay scale when said diagnosis code has a corresponding EBM treatment guideline and said medical practitioner indicates compliance with the said EBM treatment guideline and said medical practitioner prescribes information therapy for said patient.

10. The method of claim 1, wherein said website automatically selects the highest pay scale when said diagnosis code has a corresponding EBM treatment guideline and said medical practitioner indicates non-compliance with the said EBM treatment guideline while providing an explanation of the reason for non-compliance with the EBM treatment guidelines.

11. The method of claim 1, wherein said website automatically selects the highest pay scale when said diagnosis code has a corresponding EBM treatment guideline and said medical practitioner indicates non-compliance with the said EBM treatment guideline while providing an explanation of the reason for non-compliance with the EBM treatment guidelines and said medical practitioner prescribes information therapy for said patient.

12. A method for delivering health care services comprising the steps of:
receiving a claim for medical services from a medical practitioner, said claim including at least one code corresponding to at least one medical diagnosis;
comparing said code to a data base of medical diagnoses;
sending a notice to the medical practitioner when said code corresponds to a medical diagnosis found in said data base;
providing the medical practitioner access to an website, said website provides the medical practitioner with access to guidelines for EBM treatment of said medical diagnosis;
said website provides the means for the medical practitioner to confirm medical treatment within the scope of the EBM treatment guidelines;
said website providing said medical practitioner with the option of prescribing information therapy;
said website automatically generating a notice for transmission to a patient when said medical practitioner prescribes information therapy;
said website providing said patient with access to medical information relating to said medical diagnosis;
monitoring the access of said medical information by said patient;
providing said patient with a knowledge exam to determine said patient's understanding of the medical diagnosis;
automatically scoring said knowledge exam; and,
forwarding the knowledge exam results to patient's health care network.

13. A method for delivering health care services comprising the steps of:
receiving a claim for medical services from a medical practitioner, said claim including at least one code corresponding to at least one medical diagnosis;
comparing said code to a data base of medical diagnoses;
sending a notice to the medical practitioner when said code corresponds to a medical diagnosis found in said data base;
providing the medical practitioner access to an website, said website provides the medical practitioner with access to guidelines for EBM treatment of said medical diagnosis;
said website provides the means for the medical practitioner to confirm medical treatment within the scope of the EBM treatment guidelines;
said website providing the means for monitoring the medical practitioner's access of said EBM treatment guidelines;
said website selecting a compensation pay scale based on said medical practitioner's response to said request for confirmation of medical treatment within the scope of said EBM treatment guidelines;
said website selecting between at least two pay scales;
said website providing said medical practitioner with the option of prescribing information therapy;
said website automatically generating a notice for transmission to a patient when said medical practitioner prescribes information therapy;
said website providing said patient with access to medical information relating to said medical diagnosis;
monitoring the access of said medical information by said patient;
providing said patient with a knowledge exam to determine said patient's understanding of the medical diagnosis;
automatically scoring said knowledge exam; and,
forwarding the knowledge exam results to patient's health care network.

14. A method for delivering health care services comprising the steps of:
receiving a claim for compensation for medical services from a medical practitioner for medical treatment of a patient, said claim including at least one diagnosis code corresponding to at least one medical treatment received by said patient;
determining if said diagnosis code corresponds to a medical diagnosis found in a data base of medical diagnoses;
providing the medical practitioner access to a website, said website provides the medical practitioner with access to treatment guidelines for said medical diagnoses;
said website requests the medical practitioner to confirm medical treatment within the scope of said treatment guidelines;
monitoring the medical practitioner's access of said treatment guidelines;
selecting a compensation pay scale based on said medical practitioner's response to request for confirmation of treatment within the scope of said treatment guidelines.

15. The method of claim 14, further comprising the steps of:
said website providing said medical practitioner with the option of prescribing information therapy for said patient; and,
said website generating a notice for transmission to said patient when said medical practitioner prescribes information therapy.

16. The method of claim 14, wherein following receipt of the claim for compensation for medical services from a medical practitioner, further comprising the step of comparing said medical diagnosis code to said data base containing said treatment guidelines.

17. The method of claim 14, further comprising the step of monitoring the medical practitioner's access of said treatment guidelines.

18. The method of claim 14, further comprising the step of selecting a compensation rate from between at least two pay scales, the selected pay scale being based on said medical practitioner's response to request for confirmation of treatment within the scope of said treatment guidelines.

19. The method of claim 14, further comprising the step of selecting a compensation rate between at least three pay scales, the selected pay scale being based on said medical practitioner's response to request for confirmation of treatment within the scope of said treatment guidelines.

20. The method of claim 14, wherein the lowest available pay scale is selected when said medical practitioner does not prescribe information therapy for said patient.

21. The method of claim 14, wherein an intermediate pay scale is selected when said medical practitioner does not prescribe information therapy for said patient.

22. The method of claim 14, wherein the highest pay scale is selected when said medical practitioner does not prescribe information therapy for said patient.

23. The method of claim 16, wherein an intermediate pay scale is selected if the diagnosis code is not found within said data base of treatment guidelines.

24. The method of claim 16, further comprising the step of selecting the highest pay scale when said diagnosis code is found in said data base of treatment guidelines and said medical practitioner indicates compliance with said treatment guidelines.

25. The method of claim 16, further comprising the step of selecting the highest pay scale when said diagnosis code is found in said data base of treatment guidelines and said medical practitioner indicates compliance with said treatment guidelines and prescribes information therapy for said patient.

26. The method of claim 16, further comprising the step of selecting the highest pay scale when said diagnosis code is found in said data base of treatment guidelines and said medical practitioner indicates non-compliance with said treatment guidelines while providing an explanation of the reason for non-compliance with said treatment guidelines.

27. The method of claim 16, further comprising the step of selecting the highest pay scale when said diagnosis code is found in said data base of treatment guidelines and said medical practitioner indicates non-compliance with said treatment guidelines while providing an explanation of the reason for non-compliance with the treatment guidelines and said medical practitioner prescribes information therapy for said patient.

28. The method of claim 16, further comprising the steps of:
selecting the highest pay scale when said diagnosis code is found in said data base of treatment guidelines and said medical practitioner indicates non-compliance with said treatment guidelines while providing an explanation of the reason for non-compliance with the treatment guidelines; and,
monitoring the frequency of non-compliant treatments by said medical practitioner.

29. The method of claim 15, further comprising the steps of:
said website providing said patient access to medical information relating to said medical diagnosis;
monitoring said patient's access of said medical information;
providing said patient with a knowledge exam to determine said patient's understanding of the medical diagnosis;
scoring said knowledge exam; and,
providing said patient with the means for forwarding the patient's knowledge exam results to patient's health care network.

30. The method of claim 14, further comprising the step of monitoring the frequency of treatments by said medical practitioner which do not comply with said treatment guidelines.

31. The method of claim 15, further comprising the step of said medical practitioner informing said health care network of patient's non-compliance with said information therapy.

32. The method of claim 1, further comprising the steps of:
said website providing said patient with access to medical information relating to said medical diagnosis;
monitoring said patient's access of said medical information;
providing said patient with a knowledge exam to determine said patient's understanding of the medical diagnosis;
scoring said knowledge exam; and,
providing said patient the option of forwarding the patient's knowledge exam results to patient's health care network.

33. The method of claim 1, wherein an intermediate pay scale is selected when said medical practitioner does not prescribe information therapy for said patient.

34. The method of claim 1, wherein the highest pay scale is selected when said medical practitioner does not prescribe information therapy for said patient.

35. The method of claim 1, further comprising the step of monitoring the frequency of treatments by said medical practitioner which do not comply with said EBM treatment guidelines.

36. The method of claim 1, further comprising the step of said medical practitioner informing said health care network of patient's non-compliance with said information therapy.

37. The method of claim 12, further comprising the step of monitoring the medical practitioner's access of said EBM treatment guidelines.

38. The method of claim 12, further comprising the step of selecting a compensation rate from between at least two pay scales, the selected pay scale being based on said medical practitioner's indication of compliance or non-compliance with treatment within the scope of said EBM treatment guidelines.

39. The method of claim 12, further comprising the step of selecting a compensation rate between at least three pay scales, the selected pay scale being based on said medical practitioner's indication of compliance or non-compliance with treatment within the scope of said EBM treatment guidelines.

40. The method of claim 39, wherein an intermediate pay scale is selected if the diagnosis code does not have a corresponding EMB treatment guideline.

41. The method of claim 39, further comprising the step of selecting the highest pay scale when said diagnosis code has a corresponding EMB treatment guideline and said medical practitioner indicates compliance with said EBM treatment guidelines.

42. The method of claim 39, further comprising the step of selecting the highest pay scale when said diagnosis code has a corresponding EMB treatment guideline and said medical practitioner indicates non-compliance with said EBM treatment guidelines while providing an explanation of the reason for non-compliance with said EBM treatment guidelines.

43. The method of claim 12, further comprising the step of said medical practitioner informing said health care network of patient's non-compliance with said information therapy.

44. The method of claim 13, further comprising the step of selecting a compensation rate between at least three pay scales, the selected pay scale being based on said medical practitioner's response to request for confirmation of treatment within the scope of said EBM treatment guidelines.

45. The method of claim 13, wherein said website selects the lowest available pay scale when said medical practitioner does not prescribe information therapy for said patient.

46. The method of claim 13, wherein said website selects an intermediate pay scale when said medical practitioner does not prescribe information therapy for said patient.

47. The method of claim 13, wherein said website selects the highest pay scale when said medical practitioner does not prescribe information therapy for said patient.

48. The method of claim 13, wherein said website selects an intermediate pay scale if the diagnosis code does not have a corresponding EMB treatment guideline.

49. The method of claim 13, wherein said website selects the highest pay scale when said diagnosis code has a corresponding EMB treatment guideline and said medical practitioner indicates compliance with said EBM treatment guidelines.

50. The method of claim 13, wherein said website selects the highest pay scale when said diagnosis code has a corresponding EMB treatment guideline and said medical practitioner indicates compliance with said EBM treatment guidelines and said medical practitioner prescribes information therapy for said patient.

51. The method of claim 13, wherein said website selects the highest pay scale when said diagnosis code has a corresponding EMB treatment guideline and said medical practitioner indicates non-compliance with said EBM treatment guidelines while providing an explanation of the reason for non-compliance with the EBM treatment guidelines.

52. The method of claim 13, wherein said website selects the highest pay scale when said diagnosis code has a corresponding EMB treatment guideline and said medical practitioner indicates non-compliance with said EBM treatment guidelines while providing an explanation of the reason for non-compliance with the EBM treatment guidelines and said medical practitioner prescribes information therapy for said patient.

53. The method of claim 13, wherein said website selects the highest pay scale when said diagnosis code has a corresponding EMB treatment guideline and said medical practitioner indicates non-compliance with said EBM treatment guidelines while providing an explanation of the reason for non-compliance with said EBM treatment guidelines and wherein said website monitors the frequency of non-compliant treatments by said medical practitioner.

54. The method of claim 13, further comprising the step of monitoring the frequency of treatments by said medical practitioner which do not comply with said EBM treatment guidelines.

55. The method of claim 13, further comprising the step of said medical practitioner informing said health care network of patient's non-compliance with said information therapy.
